(19) United States
(12) Patent Application Publication
(10) Pub. No.: US 2015/0118417 A1
(43) Pub. Date: Apr. 30, 2015

(54) Pop-up Ornament

(71) Applicants: David Bradstreet, Toronto (CA); Brenda Bradstreet, Toronto (CA)

(72) Inventors: David Bradstreet, Toronto (CA); Brenda Bradstreet, Toronto (CA)

(21) Appl. No.: 14/066,865

(22) Filed: Oct. 30, 2013

(51) Int. Cl. G09F 1/06

(52) U.S. Cl. CPC G09F 1/06
USPC 428/9

(57) ABSTRACT

This invention provides a printed and die-cut, new, three-dimensional ornament, (in this case an octahedron), that can be mailed flat, that pops up into its final shape without assembly by the recipient when removed from the included flat envelope. Manufactured from paper card stock or other sheet material. There are three glue flaps forming four equally shaped triangles on the top and bottom portions of the ornament, joined by a center fold. Attached to hook-and-ball finding at each longitudinal end is an elastic or tensioner which recovers the size and shape of the ornament after it is extended to fold the ornament flat. Ornament returns to its final shape once released from sleeve. This item is used to communicate with recipient by means of a combination gift and greeting or promotional message or advertising through corporate branding of ornament and/or sleeve when combined with ornament.

This invention relates to a pop-up ornament that ships flat and pops up into a three-dimensional form when released from an envelope or sleeve.

There are ornaments and there are paper greetings, but ornaments are usually fragile and bulky to mail, and greetings are usually flat and devoid of an enclosed gift item.

The inventive idea of this new item is the novelty of sending or presenting a flat envelope or sleeve with a greeting to the recipient and having a fully three dimensional ornament pop-up once released from the sleeve without any assembly by the recipient. This is accomplished with an internal tensioner that allows the ornament to be folded flat and return to its original pre-assembled shape.

### DESCRIPTION

FIG. 1 is a flat plane drawing of the die-cut unfolded shape. It is comprised of eight equal shaped triangles. All dotted lines represent fold lines and the planar material is all folded to the same side of the piece of stock.

There are three glue flaps in total.

There are three folds between each set of four joined triangles.

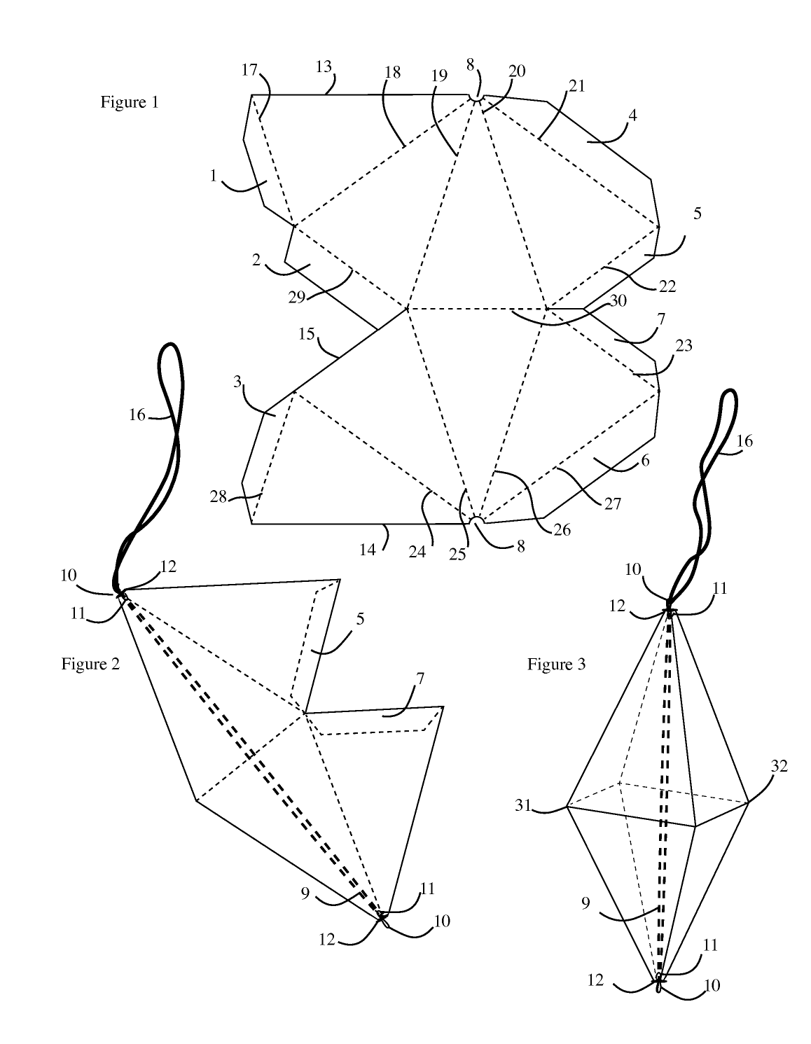

FIG. 2 is a side view folded and assembled ornament with an adhesive or other fastener. The heavy dotted line (9) represents an elastic band or other tensioner and a split ball and/or ring and hook (10, 11) finding (12).

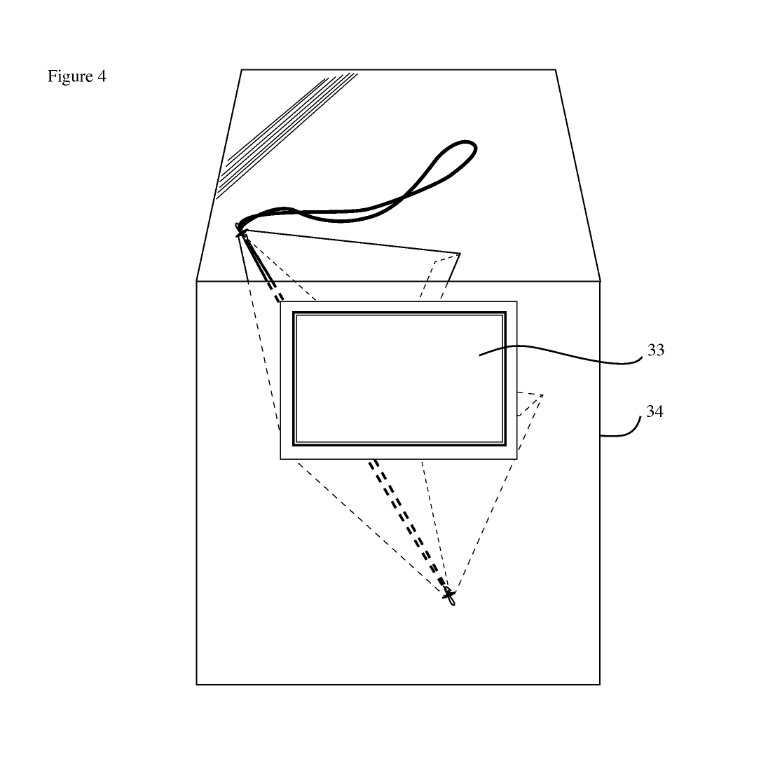

FIG. 3 is the ornament fully formed by removing ornament from envelope (FIG. 4.)

The pop-up ornament is formed by initially folding along all fold lines (17, 18, 19, 20, 21, 22, 23, 24, 25, 26, 27, 28, 29, 30). Attach glue flap (6) to surface (14) using fold 27. Attach glue flap (4) to surface (13) using fold 21. Then attach glue flap (2) to surface (15) using fold (29). Fold flaps (1, 3, 5 and 7) under, unglued, using folds (17, 22, 23 and 28). Using finding (12), attach elastic or tensioner to hooks (11) through holes (8) in both longitudinal ends. Ribbon (16), as a loop, is attached to one finding through the split ball component (10), thus hiding the knot.

The ornament is flattened by gently pushing on two points (31, 32) and is inserted in envelope (34) included (FIG. 4).

Salutation or advertising is written on the space provided (35) and then can be mailed or presented directly to the recipient.

FIG. 4 represents an envelope (34) and a place to write a greeting or promotional message (35).

That which is claimed is:

1. A pop-up ornament that ships flat in an envelope or sleeve and “pops-up” to form a three-dimensional object without any assembly by the recipient, comprising:

2. The pop-up ornament of claim 1, wherein the body of the pop-up ornament is formed of a single sheet of cardstock or other planar material.

3. The pop-up ornament of claim 2, wherein in this case is a flattened octahedron.

4. The pop-up ornament of claim 3, wherein said sheet is folded along the longitudinal side of each triangle.

5. The pop-up ornament of claim 4, wherein said sheet is folded along the base of the two connected bases of the two sets of four triangles.

6. The pop-up ornament of claim 1, wherein said triangles can be connected to each other to form the octahedron, by means of glue flaps and adhesive or other connecting methods.

7. The pop-up ornament of claim 1, wherein there are folded non-attached flaps on the base of four of the triangles that add stability and prevent collapsing of the two opposing three-dimensional halves into each other.

8. The pop-up ornament of claim 1, wherein pop-up ornament has a finding comprising a hook with split ball and/or ring at both ends of the ornament, and an elastic or other tensioner capable of recovering size and shape after being extended to fold the ornament into a flat plane.

9. The pop-up ornament of claim 1, wherein pop-up ornament can be collapsed with slight pressure into a flat plane after assembly.

10. The pop-up ornament of claim 1, wherein pop-up ornament is created by releasing the tension created by encasing the ornament in a sleeve or envelope thus returning the pop-up ornament to the original three-dimensional shape once removed from the envelope or sleeve.

11. The pop-up ornament of claim 1, wherein pop-up ornament has an envelope with a space provided to write a greeting or promotional message that is used to ship or present the ornament to the recipient, and/or to hold re-collapsed ornament to be stored for future use.

12. The pop-up ornament of claim 11, wherein pop-up ornament envelope and/or the pop-up ornament can display text, images and/or other forms of advertisement.

13. The pop-up ornament of claim 1, wherein when pop-up ornament is extracted from envelope or sleeve provides the element of surprise for the recipient.

14. The pop-up ornament of claim 1, wherein pop-up ornament, with respect to the above description, it is realized that modifications to dimensions and shape, including variations in materials that would be deemed apparent and obvious to one skilled in the art are intended to be encompassed in this invention.
